(19) United States
(12) Patent Application Publication
(10) Pub. No.: US 2026/0348744 A1
(43) Pub. Date: Nov. 5, 2026

(54) INDUCTIVE POSITION SENSOR WITH TRACKING LOOP

(71) Applicant: SEMICONDUCTOR COMPONENTS INDUSTRIES, LLC, Scottsdale, AZ (US)

(72) Inventor: Jacques Jean BERTIN, Pocatello, ID (US)

(73) Assignee: SEMICONDUCTOR COMPONENTS INDUSTRIES, LLC, Scottsdale, AZ (US)

(21) Appl. No.: 19/197,774

(22) Filed: May 2, 2025

(51) Int. Cl. G01D 5/22; G01B 7/30

(52) U.S. Cl. CPC G01D 5/22; G01B 7/30

(57) ABSTRACT

A position sensor interface is disclosed. The position sensor interface includes a modulator configured to convert a plurality of digital feedback signals into a plurality of pulse-density modulated (PDM) signals. The position sensor interface further includes a multiplier configured to respectively multiply the plurality of PDM signals with a plurality of differential receiver signals. The multiplier includes a plurality of analog multiplexors configured to receive the plurality of differential receiver signals, each of the plurality of analog multiplexors having a differential multiplexor output coupled to a differential output of the multiplier. The multiplier further includes a control circuit configured to control each of the plurality of analog multiplexors based on the plurality of PDM signals.

### TECHNICAL FIELD

The disclosure relates generally to position sensors, and particularly to high-speed inductive position sensors with a tracking loop.

### BACKGROUND

Many applications requiring movement, such as automotive and robotic applications among others, require measurements of angular position (for example, pedal angle or arm angle). An inductive position sensor may be desirable for such applications because it can provide accurate measurements while withstanding difficult environmental conditions. For example, inductive position sensors can be used to measure an angular position of a rotating element by sensing a change in magnetic coupling between stationary coil and a rotor coil moving with the rotating element.

Increasing the speed and/or resolution of these position sensors may be desirable but can be limited by a corresponding increase in the cost of fabrication. The inventor of embodiments of the present disclosure has recognized that techniques for increasing the accuracy of magnetic position sensors have typically come at the expense of measurement speed. The inventor of embodiments of the present disclosure has also recognized that techniques for increasing the speed of magnetic position sensors have typically come at the expense of accuracy. Embodiments of the present disclosure may address one or more of these challenges.

### BRIEF DESCRIPTION OF THE DRAWINGS

A more complete understanding of the present embodiments may be acquired by referring to the following description taken in conjunction with the accompanying drawings, in which like reference numbers indicate like features.

FIG. 1 illustrates an angular position sensor in accordance with embodiments of the present disclosure.

FIG. 2A illustrates a schematic circuit model of an angular position sensor in accordance with embodiments of the present disclosure.

FIG. 2B illustrates a schematic circuit model of a 3-phase receiver coil set in accordance with embodiments of the present disclosure.

FIG. 3 illustrates a schematic diagram of a position sensor system in accordance with embodiments of the present disclosure.

FIG. 4 illustrates operating states of analog multiplexors in accordance with embodiments of the present disclosure.

FIG. 5 illustrates the operational states of a multiplier in accordance with embodiments of the present disclosure.

FIG. 6 illustrates a schematic diagram of a position sensor system in accordance with embodiments of the present disclosure.

FIG. 7 illustrates operation of an example method of operating a position sensor interface in accordance with embodiments of the present disclosure.

### DETAILED DESCRIPTION

Details of one or more embodiments are set forth in the description below and the accompanying drawings. Other features will be apparent from the description, drawings, and from the claims. The embodiments disclosed should not be interpreted, or otherwise used, as limiting the scope of the disclosure, including the claims. In addition, one skilled in the art understands that the following description has broad application, and the discussion of any embodiment is meant to be exemplary of that embodiment, and not intended to intimate that the scope of the disclosure, including the claims, is limited to that embodiment.

Various terms are used to refer to particular system components. Different companies may refer to a component by different names, and this disclosure does not intend to distinguish between components that differ in name but not form and function. In the following discussion and in the claims, the terms “including” and “comprising” are used in an open-ended fashion, and thus should be interpreted to mean “including, but not limited to.” Also, the term “couple” or “coupled” is intended to encompass either an indirect connection or a direct connection. Thus, if a first device couples to, or is coupled to, a second device, that connection between the first device and the second device may be through a direct connection or through an indirect connection via other devices and connections.

Further, although the terms “first,” “second,” and so forth may be used herein to describe various elements, these elements should not be limited by these terms. Terms such as “first” and “second” may be used merely to distinguish one element from another. For example, a first element could be termed a second element, and, similarly, a second element could be termed a first element, without departing from the scope of the present disclosure. Further, the identification of a “first” element, does not necessarily require the presence of a “second” element. As used herein, the term “and/or” includes any and all combinations of one or more of the associated listed items.

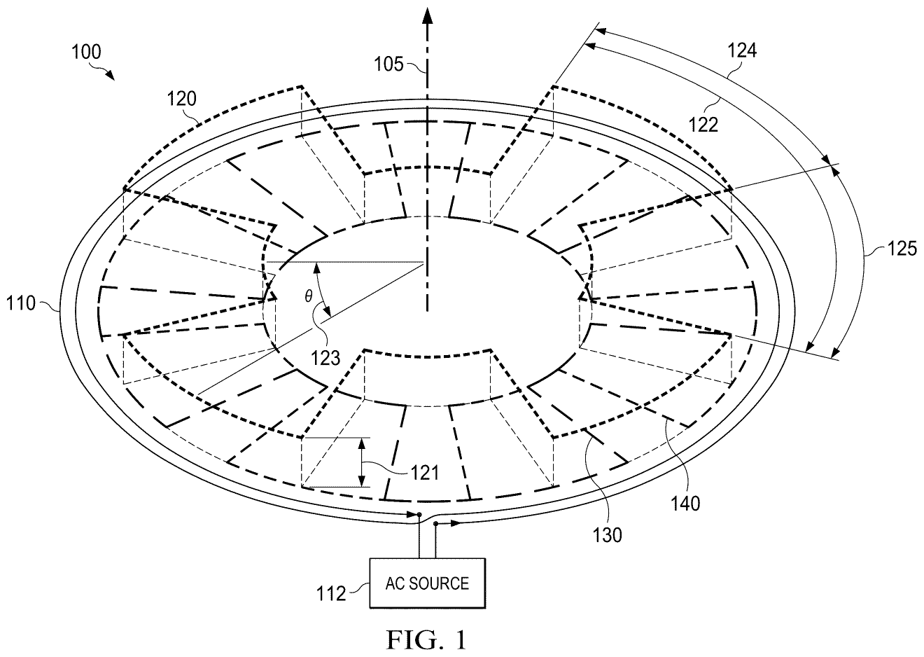

FIG. 1 illustrates angular position sensor 100 in accordance with embodiments of the present disclosure. Angular position sensor 100 may include excitation coil 110, alternating-current (AC) voltage source 112, rotor coil 120, and a plurality of receiver coils including a first receiver coil 130 and a second receiver coil 140.

Excitation coil 110 may be stationary and may be coupled to AC voltage source 112. AC voltage source 112 may be configured to generate an excitation signal at a frequency (for example a radio frequency (RF)). In some embodiments, the excitation signal may have a frequency, for example, in the megahertz (MHz) range of the electromagnetic spectrum. Excitation coil 110 may be planar and may define a first plane. Electrical current in excitation coil 110 may generate an excitation (magnetic) field transverse to the first plane. Excitation coil 110 may have a circular shape that may be substantially symmetric around an axis-of-symmetry 105 that is located at the center of excitation coil 110 and that is transverse to the plane of the excitation coil. For example, excitation coil 110 may be a spiral having multiple turns. The spiral may form a ring (or an annulus) and the other coils may be located within the ring (or annulus), as shown, or outside the ring (or annulus). As described directly below, excitation coil 110 may magnetically couple to rotor coil 120.

Rotor coil 120 may be planar and may define a second plane. The second plane defined by rotor coil 120 may be separated from the first plane defined by excitation coil 110 by an air gap 121. Due to the symmetric loop formation of excitation coil 110, the inductive coupling between excitation coil 110 and rotor coil 120 may be independent of the rotor angle (0). However, the inductive coupling between excitation coil 110 and rotor coil 120 may be a function of the air gap 121. For example, the exciter-to-rotor inductive coupling decreases as the distance of the air gap 121 between excitation coil 110 and rotor coil 120 is made larger. Likewise, the excitor-to-rotor inductive coupling increases as the distance of the air gap 121 between excitation coil 110 and rotor coil 120 is made smaller.

Rotor coil 120 may be planar and movable and may be rotated to a rotor angle 123 (θ) about the axis-of-symmetry 105 that intercepts the plane of rotor coil 120 at the center of the rotor coil 120. Rotor coil 120 may form a pattern with an angular (0) dependency that repeats. For example, rotor coil 120 may form a pattern with an angular (0) dependency that has a rotational symmetry. The pattern may include a plurality of lobes. For example, as shown in FIG. 1, the rotor coil 120 may have four lobes positioned regularly around the axis-of-symmetry 105. Each lobe may have a mechanical period 122 that includes a positive portion (positive lobe 124) and a negative portion (negative lobe 125). The positive lobe 124 as shown in FIG. 1 may be defined as a portion of rotor coil 120 at a first radius from the axis-of-symmetry 105. Further, the negative lobe 125 as shown in FIG. 1 may be defined as a portion of rotor coil 120 at a second radius from the axis-of-symmetry 105, where the first radius is larger than the second radius. In other words, rotor coil 120 may be rotationally symmetric around the axis-of-symmetry 105 where an order of the rotational symmetry may correspond to the number of lobes (periods). For example, the embodiment of rotor coil 120 shown in FIG. 1 may be described as having a rotational symmetry of the 4th order (symmetry of 4). As described in further detail below, the 4th-order rotational symmetry of rotor coil 120 (along with similar symmetry of the receiver coils) may result in an electrical receiver signal with an angular (θ) dependency that repeats four times over one full 360 degree mechanical rotation.

Rotor coil 120 may be configured to receive an excitation signal from the excitation coil 110 through the exciter-to-rotor inductive coupling. The magnetic field coupled from excitation coil 110 may induce a current to flow in rotor coil 120. In turn, rotor coil 120 may generate a secondary field corresponding to the excitation signal. As described directly below, this secondary field may interact with a plurality of receiver coils.

A plurality of receiver coils (such as first receiver coil 130 and second receiver coil 140) may be configured to receive the secondary field of rotor coil 120 through inductive coupling between the rotor coil 120 and the receiver coils. The plurality of receiver coils may each be planar. Further, the plurality of receiver coils may be placed in the same plane (the first plane), or approximately the same plane, as excitation coil 110. For example, the plurality of receiver coils may occupy a plane that is parallel to, and within in the range of plus or minus 1000 microns away from, the first plane in which excitation coil 110 is located. Accordingly, the inductive coupling between rotor coil 120 and the plurality of receiver coils (rotor-to-receiver inductive coupling) may be a function of the air gap 121. For example, the rotor-to-receiver inductive coupling decreases as the distance of the air gap 121 between rotor coil 120 and the plurality of receiver coils is made larger. Likewise, the rotor-to-receiver inductive coupling increases as the distance of the air gap 121 between rotor coil 120 and the plurality of receiver coils is made smaller.

The plurality of receiver coils may be stationary relative to the movement (rotation) of the rotor coil 120. As shown in FIG. 1, the plurality of receiver coils may include first receiver coil 130 and second receiver coil 140. First receiver coil 130 may form a first pattern that is substantially the same as the pattern of the rotor coil 120. Likewise, second receiver coil 140 may form a second pattern that is substantially the same as the pattern of the rotor coil 120. In other words, the first pattern of first receiver coil 130 may be substantially the same as the second pattern of second receiver coil 140. As shown in FIG. 1, first receiver coil 130 and second receiver coil 140 may have an angular shift relative to each other of one quarter of the mechanical period 122 of rotational symmetry around the axis-of-symmetry 105. In other words, the plurality of receiver coils, including for example first receiver coil 130 and second receiver coil 140, may be spatially rotated relative to each other.

As rotor coil 120 rotates about axis-of-symmetry 105, the inductive coupling between the rotor coil 120 and first receiver coil 130 may change. For example, the inductive coupling between rotor coil 120 and first receiver coil 130 may be at a maximum at angles for which the patterns (for example the respective positive lobes and negative lobes) are aligned. Conversely, the inductive coupling between rotor coil 120 and first receiver coil 130 may be at a minimum at angles for which the negative lobes of rotor coil 120 are aligned with positive lobes of first receiver coil 130.

As rotor coil 120 rotates about axis-of-symmetry 105, the inductive coupling between the rotor coil 120 and second receiver coil 140 may change. For example, the inductive coupling between rotor coil 120 and second receiver coil 140 may be at a maximum at angles for which the patterns (for example the respective positive lobes and negative lobes) are aligned. Conversely, the inductive coupling between rotor coil 120 and second receiver coil 140 may be at a minimum at angles for which the negative lobes of rotor coil 120 are aligned with positive lobes of second receiver coil 140.

First receiver coil 130 may generate a first received signal that varies sinusoidally according to the angle (θ) of rotor coil 120. For the example implementation shown in FIG. 1, the first received signal may repeat four times during one complete revolution of rotor coil 120. For the example, as shown in FIG. 1, rotating the rotor over a range of angles corresponding to the mechanical period 122 of rotational symmetry (for example 90 degrees) may correspond to one electrical period of the first received signal. In other words, the first received signal may have a spatial frequency corresponding to the order of rotational symmetry (for example, four). Likewise, the second receiver coil 140 may generate a second received signal that varies sinusoidally and repeats four times during one complete revolution of the rotor coil 120. The first received signal and the second received signal may have the same frequency but may be electrically phase shifted relative to each other due to the angular offset between first receiver coil 130 and second receiver coil 140.

An electrical phase shift (for example 90 degrees electrical) between the first received signal and the second received signal may correspond to the angular shift (for example 22.5 degrees mechanical) between the respective receiver coils. The first received signal and the second received signal may be in quadrature so the first received signal corresponds to the sine of the angle (SIN(θ)), and the second received signal corresponds to the cosine of the angle (COS(θ)). Therefore, an angle (θ) measurement may be computed as the inverse tangent of the received signals (θ=tan-1 (sin (θ)/cos (θ))). In some embodiments, such an inverse tangent calculation approach may be desirable because amplitude changes that are common to the first received signal and the second received signal cancel.

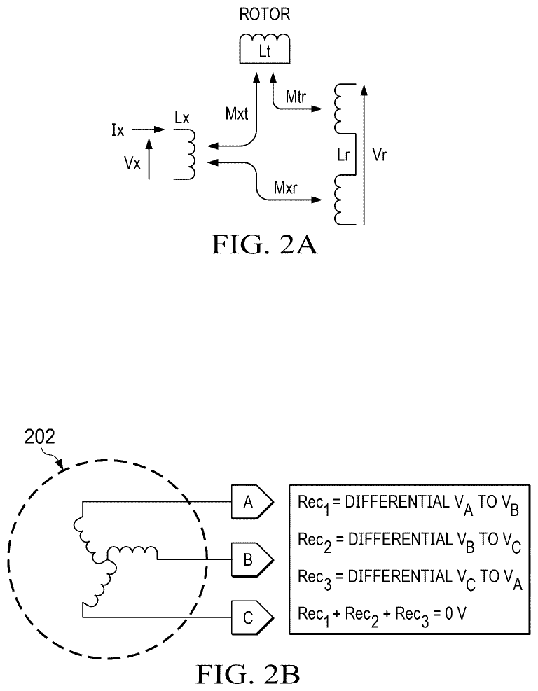

FIG. 2A illustrates a schematic circuit model of an angular position sensor in accordance with embodiments of the present disclosure. For example, FIG. 2A illustrates a schematic circuit model of portions of angular position sensor 100 described above with reference to FIG. 1. Excitation coil 110 is modeled as an exciter inductance (Lx), rotor coil 120 is modeled as a rotor inductance (Lt), and a receiver coil (which could be either one or first receiver coil 130 or second receiver coil 140 for example) is modeled as a receiver inductance (Lr). The exciter coil and the rotor coil are inductively coupled through an exciter-rotor mutual inductance (Mxt). The exciter coil and the receiver coil are inductively coupled through an exciter-receiver mutual inductance (Mxr), which is constant with angle. The rotor coil and the receiver coil are inductively coupled through a rotor-receiver mutual inductance (Mtr). Accordingly, the receiver coil voltage (Vr) may be related to the excitation current (Ix) by the following equation:

$${V}_{r} = ( \frac{{M}_{xr}}{{L}_{x}} - \frac{{M}_{xt} ( z ) {M}_{tr} ( z , θ )}{{L}_{t} {L}_{x}} ) {V}_{x}$$

In the equation above, the coil voltage (Vr) is a function of the air gap (z) and the angle (θ). In a first approximation, the rotor-receiver mutual inductance (Mₜᵣ) is a product of a first function of the air gap (M(z)) and a second function of the angle (M(θ)), where the second function is a pure sine or cosine. Accordingly, the coil voltage (Vr) may be a sinusoidal function with the angle (θ).

The sinusoidal coil voltage may progress through multiple cycles as the rotor coil completes one revolution. For the example shown in FIG. 1, the coil voltage has four electrical cycles for every one mechanical revolution. Further, the coil voltage may vary as a function of the air gap dependency. Accordingly, it may not be possible to determine an angle from one coil voltage. As a result, a practical inductive sensor may include multiple receiver coils with the same air gap dependency. In such embodiments, the angle may be determined based on the ratio of the signals from the multiple receiver coils, whereby the equal air gap dependencies of the different receiver coils cancel out. For example, as described above with reference to FIG. 1, the inductive position sensor may include two receiver coils, including first receiver coil 130 and a second receiver coil 140. In other embodiments, an inductive position sensor may include three receiver coils for example. For either such example, the multiple receiver coils in a given embodiment may be identically shaped with respect to each other (for example have the same number of lobes). The multiple receiver coils may also by symmetric around a common axis of rotation, and planar on a common plane. The receiver coils may be evenly spaced and mechanically rotated with respect to each other. For example, when three receiver coils are implemented, each of the three receiver coils may be mechanically positioned relative to each other at plus and minus one-third of the mechanical period 122, thereby resulting in three electrical receiver signals plus and minus 120 degrees from each other to create a rotationally symmetric and repeating 360 degree pattern.

FIG. 2B illustrates a schematic circuit model of 3-phase receiver coil set 202 in accordance with embodiments of the present disclosure. As shown in FIG. 2B, the 3-phase receiver coil set 202 may include three receiver coils. Each of the three receiver coils may be inductively coupled to a rotor coil of an angular position sensor in a similar manner as described above for the receiver coils in FIG. 1 and FIG. 2A. As also shown in FIG. 2B, the three receiver coils may be coupled in a Y-configuration (also referred to as a Wye-configuration). Differential receiver signals such as Rec₁, Rec₂, and Rec₃ may be provided by the 3-phase receiver coil set 202. For example, differential receiver signal Rec₁ may represent the differential between the voltage at node A (V_{A}) and the voltage at node B (V_{B}). Further, differential receiver signal Rec₂ may represent the differential between the voltage at node B (V_{B}) and the voltage at node C (V_{C}). In addition, differential receiver signal Rec₃ may represent the differential between the voltage at node C (V_{C}) and the voltage at node A (V_{A}). As described by Kirchoff's voltage law, the sum of Rec₁, Rec₂, and Rec₃ is zero volts.

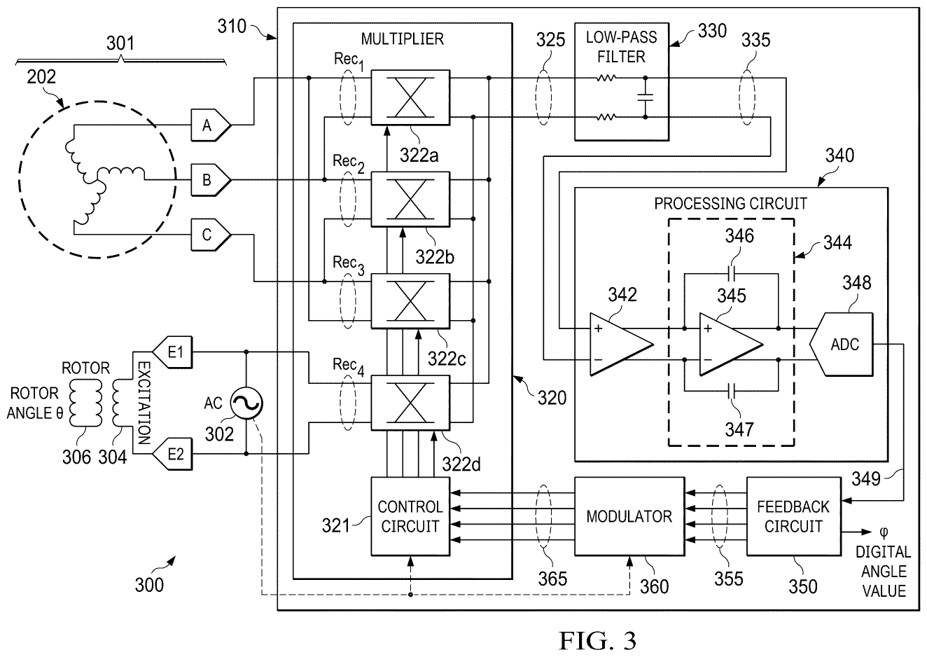

FIG. 3 illustrates a schematic diagram of position sensor system 300 in accordance with embodiments of the present disclosure. Position sensor system 300 may be implemented in any suitable fashion according to the operation described in the present disclosure. As shown in FIG. 3, position sensor system 300 may include angular position sensor 301. Angular position sensor 301 may include AC source 302, excitation coil 304, rotor coil 306, and a 3-phase receiver coil set 202. Excitation coil 304 may be configured to be driven by AC source 302. Rotor coil 306 may be inductively coupled to excitation coil 304. Further, the 3-phase receiver coil set 202 may be inductively coupled to rotor coil 306.

In some embodiments, excitation coil 304 may be differentially driven by AC source 302 at a frequency. As described in further detail below, the sampling frequency of position sensor interface 310 may be synchronized to the frequency of AC source 302. Thus, AC source 302 may drive excitation coil 304 any suitable frequency for sampling the angular position (0) of rotor coil 306. In some embodiments, AC source 302 may drive excitation coil 304 at a frequency of 4 MHz for example. In other embodiments, AC source 302 may drive excitation coil 304 at a frequency higher than 4 MHz or lower than 4 MHz. As described above with reference to FIG. 2B, and as shown in FIG. 3, the 3-phase receiver coil set 202 may include a plurality of receiver coils coupled in a Y-configuration and inductively coupled to rotor coil 306. The 3-phase receiver coil set 202 may thus provide three differential receiver signals in the form of Rec₁ representing the differential voltage between V_{A} and V_{B}, Rec₂ representing the differential voltage between V_{B} and V_{C}, and Rec₃ representing the differential voltage between V_{C} and V_{A}.

Position sensor system 300 may further include position sensor interface 310. Position sensor interface 310 may be implemented in any suitable fashion according to the operation described in the present disclosure. As shown in FIG. 3, position sensor interface 310 may include multiplier 320, low-pass filter 330, processing circuit 340, feedback circuit 350, and modulator 360. At a high level, the components of position sensor interface 310 may form a tracking loop that produces a digital angle value (φ) that tracks the rotor angle (θ). For example, position sensor interface 310 may receive a plurality of differential receiver signals (Rec₁, Rec₂, and Rec₃) from angular position sensor 301. The plurality of differential receiver signals (Rec₁, Rec₂, and Rec₃) may be processed to determine digital angle value (φ). As shown in FIG. 3, position sensor interface 310 may also receive a fourth input (Rec₄) corresponding to the AC source 302. The fourth input (Rec₄) may be utilized to compensate for offsets in the tracking loop that would otherwise occur due to the inductively coupling (albeit small) between excitation coil 304 and 3-phase receiver coil set 202.

Before describing examples of physical circuitry for position sensor interface 310, the mathematical principles behind the operation of position sensor interface 310 are described. As an initial matter, the plurality of differential receiver signals can be expressed according to equations 1~4 below.

Rec₁=A sin (θ)+B₁ [equation 1]

Rec₂=A sin (θ+120)+B₂ [equation 2]

Rec₃=A sin (θ+240)+B₃ [equation 3]

Rec₄=B₄ [equation 4]

In equations 1~4 above, θ is the electrical rotor angle, A is the coupling amplitude between the rotor coil and the plurality of receiver coils, and B₁, B₂, and B₃ are constant offsets proportional to the amplitude of the excitation signal and independent of rotor position. Further, B₄ is a constant coefficient proportional to the excitation signal and independent of rotor position. As described in further detail below, the tracking loop may generate a plurality of feedback signals (such as digital feedback signals 355) that may be expressed according to equations 5-8 below.

FB₁=cos (φ) [equation 5]

FB₂=cos (φ+120) [equation 6]

FB₃=cos (φ+240) [equation 7]

$${FB}_{4} = - {\sum }_{i = 1}^{3} \frac{{B}_{i}}{{B}_{4}} cos ( φ + ( ( i * 120 ) - 120 ) ) \qquad [ equation 8 ]$$

The sum of the respective products of the plurality of the receiver signals times the feedback signals may be expressed according to equation 9 below.

$${\sum }_{i = 1}^{4} R e {c}_{i} F {B}_{i} = \frac{3}{2} A sin ( θ - φ ) \qquad [ equation 9 ]$$

According to the equation 9, if the digital angle value (φ) is equal to the rotor angle (θ), then the sum of the respective products of the plurality of the receiver signals times the plurality of feedback signals may be equal to zero. Thus, to detect the rotor angle (θ), the tracking loop may continuously determine and update the digital angle value (φ) to target a value of zero for the sum of the respective products of the plurality of the receiver signals times the plurality of feedback signals.

Referring back to FIG. 3, feedback circuit 350 may be configured to generate a plurality of digital feedback signals 355 based on a digital error signal 349 from processing circuit 340. Specifically, feedback circuit 350 may determine and update the digital angle value (φ) to target a value of zero for digital error signal 349, which may represent the respective products of the plurality of the receiver signals times the plurality of feedback signals as described in the mathematical equations 1-9 above. The plurality of digital feedback signals 355 may include a first cosine signal, a second cosine signal, and third cosine signal based at least on the digital angle value (φ) In some embodiments, the plurality of digital feedback signals 355 may further include a fourth cosine signal based at least on the digital angle value (φ). For example, the plurality of digital feedback signals 355 may comprise digital representations of the feedback signals FB₁, FB₂, FB₃, and FB₄ described above in equations 5-8.

As shown in FIG. 3, modulator 360 may be coupled to receive the plurality of digital feedback signals 355 from feedback circuit 350. Modulator 360 may be configured to convert the plurality of digital feedback signals 355 into a plurality of pulse-density modulated (PDM) signals 365. In some embodiments, modulator 360 may be a sigma-delta modulator. As shown in FIG. 3, modulator 360 may be synchronized to the frequency of the excitation signal provided by AC source 302. For example, in embodiments where AC source 302 provides a 4 MHz excitation signal, modulator 360 may output the plurality of PDM signals 365 at a frequency of 4 MHz. The respective pulse densities of the plurality of PDM signal 365 may correspond to the digital values of the respective digital feedback signals 355. Accordingly, the plurality of PDM signals 365 may comprise pulse-density modulated representations of the feedback signals FB₁, FB₂, FB₃, and FB₄ described above in equations 5-8. Although modulator 360 is illustrated in FIG. 3 as a single circuit block, modulator 360 may include multiple components. For example, modulator 360 may include or be implemented by multiple modulators (for example sigma-delta modulators) each configured to modulate a respective one of the plurality of digital feedback signals 355 respectively corresponding to FB₁, FB₂, FB₃, and FB₄ described above in equations 5-8.

Although illustrated in FIG. 3 as separate circuit blocks, feedback circuit 350, modulator 360, and/or control circuit 321 may be implemented in the same block of circuitry. For example, feedback circuit 350, modulator 360, and/or control circuit 321 may be implemented together in full or in part in the same digital circuit block.

Multiplier 320 may be configured to respectively multiply the plurality of PDM signals 365 with the plurality of differential receiver signals (Rec₁, Rec₂, Rec₃, Rec₄). Multiplier 320 may be implemented in any suitable fashion according to the operation described in the present disclosure. In some embodiments, multiplier 320 may be configured to multiply Rec₁ with a first PDM signal representing FB₁, multiply Rec₂ with a second PDM signal representing FB₂, multiply Rec₃ with a third PDM signal representing FB₃, and multiply Rec₄ with a fourth PDM signal representing FB₄. Multiplier 320 may include a plurality of analog multiplexors 322a-d and a control circuit 321 configured to control each of the plurality of analog multiplexors 322a-d based on the plurality of PDM signals 365. As described in detail below, control circuit 321 and the analog multiplexors 322a-d may collectively implement the multiplication of the plurality of PDM signals 365 with the plurality of differential receiver signals (Rec₁, Rec₂, Rec₃, Rec₄).

The plurality of analog multiplexors 322a-322d may be configured to receive the plurality of differential receiver signals. In some embodiments, the plurality of differential receiver signals may include a first sine signal (Rec₁), a second sine signal (Rec₂), and a third sine signal (Rec₃), based at least on a rotor angle of angular position sensor 301. The plurality of differential receiver signals may further include a fourth signal based at least on an excitation amplitude of angular position sensor 301. For example, as described above, with reference to equations 1-4, Rec₁, Rec₂, and Rec₃ may be first, second, and third sine signals based at least on the rotor angle (θ) of angular position sensor 301. Further, Rec₄ may be a fourth signal based on a constant coefficient (B₄) proportional to the excitation signal. As shown in FIG. 3, analog multiplexor 322a may receive the first differential receiver signal (Rec₁), analog multiplexor 322b may receive the second differential receiver signal (Rec₂), analog multiplexor 322c may receive the third differential receiver signal (Rec₃), and analog multiplexor 322d may receive the fourth differential receiver signal (Rec₄).

The analog multiplexors 322a-322d may each include a number of switches or pass-gates that may be controlled by control circuit 321 to provide one of three analog multiplexor operations. Specifically, based on the plurality of PDM signals 365, each of the analog multiplexors may be configured to provide one of a non-inverting rectification of a respective one of the plurality of differential receiver signals, an inverting rectification of the respective one of the plurality of differential receiver signals, or a high-impedance output.

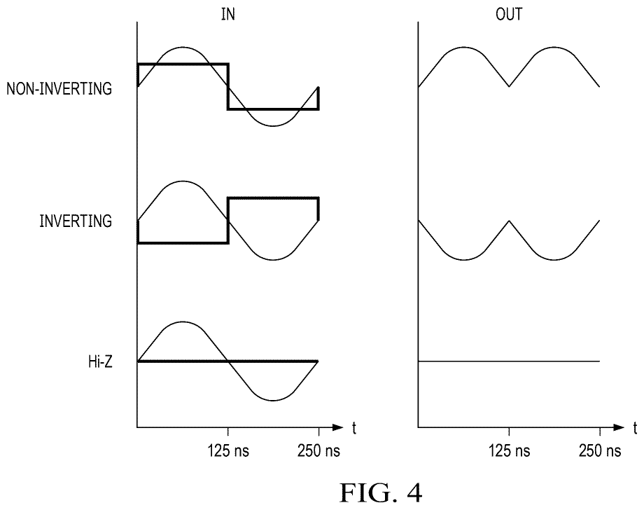

FIG. 4 illustrates operating states of the analog multiplexors 322a-322d in accordance with embodiments of the present disclosure. As described above with reference to FIG. 3, modulator 360 may be synchronized to the frequency of the excitation signal from AC source 302. In some embodiments, the excitation signal from AC source 302 may have a frequency of, for example, 4 MHz. Thus, the input sine wave for each of the analog multiplexors 322a-322d may have a period of 250 ns. As shown in FIG. 4, a non-inverting rectification of a wave signal (such as Rec₁, Rec₂, Rec₃, or Rec₄) may rectify and output a positive signal. An inverting rectification of a wave signal (such as Rec₁, Rec₂, Rec₃, or Rec₄) may rectify and output a negative signal. A high-impedance output may simply turn off all internal switches or pass gates of the analog multiplexor such that the analog multiplexor output is high impedance.

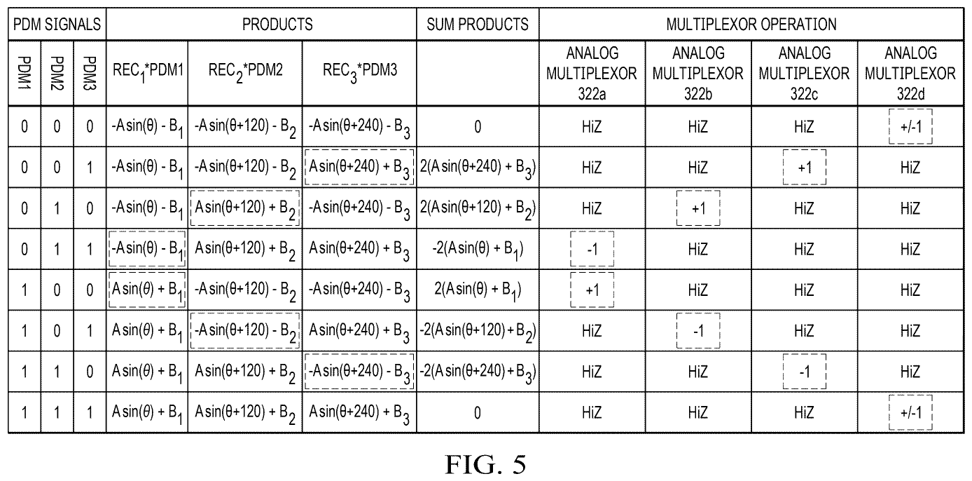

Referring back to FIG. 3, each of the analog multiplexors 322a-d may have a differential multiplexor output coupled to a differential output 325 of multiplier 320. At any given time, only one of the analog multiplexors 322a-d may provide an inverting or non-inverting rectification, while the others of the analog multiplexors 322a-d may be placed in a high-impedance state. Thus, only one of the analog multiplexors 322a-d may pass a signal to the differential output 325 of multiplier 320 at a time. The control of the analog multiplexors 322a-d to implement the multiplication of the plurality of PDM signals 365 with the plurality of differential receiver signals Rec₁, Rec₂, Rec₃, and Rec₄ is described below with reference to FIG. 5.

FIG. 5 illustrates the operational states of multiplier 320 in accordance with embodiments of the present disclosure. As described above, the plurality of PDM signals 365 may comprise pulse-density modulated representations of the feedback signals FB₁, FB₂, FB₃, and FB₄ described above in equations 5-8. The PDM signals corresponding to FB₁, FB₂, and FB₃ are represented as PDM1, PDM2, and PDM3 respectively in FIG. 5, with “0” representing logic-0 and “1” representing logic-1. As shown in FIG. 5, there are eight potential combinations of PDM1, PDM2, and PDM3, including: 0-0-0, 0-0-1, 0-1-0, 0-1-1, 1-0-0, 1-0-1, 1-1-0, and 1-1-1.

Moving to the right in FIG. 5, the mathematical products of Rec₁*PDM1, Rec₂*PDM2, and Rec₃*PDM3 are listed. For example, when PDM1 is logic-0, the product of Rec₁*PDM1 equals −A sin (θ)−B₁. And when PDM1 is logic-1, the product of Rec₁*PDM1 equals A sin (θ)+B₁. Further, when PDM2 is logic-0, the product of Rec₂*PDM2 equals −A sin (θ+120)−B₂. And when PDM2 is logic-1, the product of Rec₂*PDM2 equals A sin (θ+120)+B₂. Further, when PDM3 is logic-0, the product of Rec₃*PDM3 equals −A sin (θ+240)−B₃. And when PDM3 is logic-1, the product of Rec₃*PDM3 equals A sin (θ+240)+B₃.

Moving further to the right in FIG. 5, the sums of the products for the eight potential combinations of PDM1, PDM2, and PDM3 are considered. When PDM1, PDM2, and PDM3 are 0-0-0, the sum of the products is zero. Likewise, when PDM1, PDM2, and PDM3 are 1-1-1, the sum of the products is also zero. The sum of zero when PDM1, PDM2, and PDM3 are each in the same logic state (0-0-0 or 1-1-1) is due to Kirchoff's voltage law, which as described above with reference to FIG. 2 dictates that the sum of Rec₁+Rec₂+Rec₃ must equal zero. Given the sum of zero during these conditions for Rec₁*PDM1, Rec₂*PDM2, and Rec₃*PDM3, the analog multiplexors 322a-c corresponding to Rec₁, Rec₂, and Rec₃ may all be placed in a high-impedance state (as indicated by a “HiZ” in FIG. 5A). Further, during these conditions, analog multiplexor 322d may be placed in either a non-inverting rectification state (as indicated by a “+1”) or inverting rectification state (as indicated by a “−1”), according to the status of a fourth PDM signal corresponding to FB₄ as described above with reference to Equation 8. In other words, during the logic states when the sum of Rec₁*PDM1, Rec₂*PDM2, and Rec₃*PDM3 is equal to zero due to Kirchoff's voltage law, the analog multiplexors 322a-322c corresponding to Rec₁, Rec₂, and Rec₃ may be placed in high-impedance states to block Rec₁, Rec₂, and Rec₃, and Rec₄ may instead be passed (with either an non-inverting or an inverting rectification) to compensate for offsets described above with reference to equation 4 and equation 8.

As further shown in FIG. 5, when PDM1, PDM2, and PDM3 are not all the same logic value, the sum of the products (the sum of Rec₁*PDM1, Rec₂*PDM2, and Rec₃*PDM3) may equal a multiple of one of the three respective products. Accordingly, one of the analog multiplexors 322a-c may be placed in a non-inverting or inverting rectification state to pass a signal to the differential output 325 of multiplier 320, while the other of the analog multiplexors 322a-d are placed in a high-impedance state.

For example, when PDM1, PDM2, and PDM3 are 0-0-1 or 1-1-0, the sum of the respective products (the sum of Rec₁*PDM1, Rec₂*PDM2, and Rec₃*PDM3) may be a 2× multiple of the sum of Rec₃*PDM3. Accordingly, during these conditions (0-0-1 or 1-1-0), the analog multiplexors 322a, 322b, and 322d corresponding to Rec₁, Rec₂, and Rec₄ may be placed in a high-impedance state (HiZ). Meanwhile, the analog multiplexor 322c corresponding to Rec₃ is placed in either non-inverting rectification state (+1) during the 0-0-1 condition, or an inverting rectification state (−1) during the 1-1-0 condition, to pass a signal to the differential output 325 of multiplier 320.

As also shown in FIG. 5, when PDM1, PDM2, and PDM3 are 0-1-0 or 1-0-1, the sum of the respective products (the sum of Rec₁*PDM1, Rec₂*PDM2, and Rec₃*PDM3) may be a 2× multiple of the sum of Rec₂*PDM2. Accordingly, during these conditions (0-1-0 or 1-0-1), the analog multiplexors 322a, 322c, and 322d corresponding to Rec₁, Rec₃, and Rec₄ may be placed in a high-impedance state (HiZ). Meanwhile, the analog multiplexor 322b corresponding to Rec₂ is placed in either non-inverting rectification state (+1) during the 0-1-0 condition, or an inverting rectification state (−1) during the 1-0-1 condition, to pass a signal to the differential output 325 of multiplier 320.

Further, when PDM1, PDM2, and PDM3 are 0-1-1 or 1-0-0, the sum of the respective products (the sum of Rec₁*PDM1, Rec₂*PDM2, and Rec₃*PDM3) may be a 2× multiple of the sum of Rec₁*PDM1. Accordingly, during these conditions (0-1-1 or 1-0-0), the analog multiplexors 322b, 322c, and 322d corresponding to Rec₂, Rec₃, and Rec₄ may be placed in a high-impedance state (HiZ). Meanwhile, the analog multiplexor 322a corresponding to Rec₁ is placed in either non-inverting rectification state (+1) during the 1-0-0 condition, or an inverting rectification state (−1) during the 0-1-1 condition, to pass a signal to the differential output 325 of multiplier 320.

Based on the above described operation, multiplier 320 and the plurality of analog multiplexors 322a-322d may effectively multiply Rec₁, Rec₂, Rec₃, and Rec₄ times the plurality of PDM signals 365 representing feedback signals FB₁, FB₂, FB₃, and FB₄ described above with reference to equations 5-8, and may effectively sum the respective products. By using analog multiplexors 322a-d, the multiplication and summation may be performed without the use of different amplifiers in the respective paths of Rec₁, Rec₂, Rec₃, Rec₄. Accordingly, errors due to mismatch between such different amplifiers corresponding to Rec₁, Rec₂, Rec₃, and Rec₄ may be avoided.

Referring back to FIG. 3, position sensor interface 310 may include low-pass filter 330 coupled to filter the differential output 325 of multiplier 320. Low-pass filter 330 may be configured to filter out the high-frequency component of the rectified signal passed to the differential output 325 of multiplier 320. For example, as described above, modulator 360 may be configured to modulate the plurality of digital feedback signals 355 at the same frequency of the excitation signal provided by AC source 302. In embodiment where the excitation signal and modulator 360 have a frequency of 4 MHz, low-pass filter 330 may be configured to filter out the resulting frequency components, at 8 MHz and above for example, seen at the differential output 325 of multiplier 320.

As shown in FIG. 3, processing circuit 340 may be coupled to low-pass filter 330 to receive the filter output 335. Processing circuit may be configured to output the digital error signal 349 based on the filter output 335. Processing circuit 340 may be implemented in any suitable fashion according to the operation described in the present disclosure. Processing circuit 340 may amplify the output of low-pass filter 330, integrate the amplified output, and convert the signal from the analog domain to the digital domain. In some embodiments, processing circuit 340 may include transconductance amplifier 342, integrator 344, and analog-to-digital converter (ADC) 348.

Transconductance amplifier 342 may be configured to amplify the filter output 335. Integrator 344 may be configured to integrate an output of transconductance amplifier 342. For example, integrator 344 may include amplifier 345 having differential inputs coupled to the differential outputs of transconductance amplifier 342. Further, integrator 344 may include a first capacitor 346 coupled from a first differential input to a first differential output of amplifier 345, and a second capacitor 347 coupled from a second differential input to a second differential output of amplifier 345. Analog-to-digital converter (ADC) 348 may be configured to receive an integrator output from integrator 344 and to generate the digital error signal 349. As described above, feedback circuit 350 may receive digital error signal 349 and may determine and update the digital angle value (φ) to target a value of zero for digital error signal 349, which according to equation 9 above, would bring the digital angle value (φ) in line with (and therefore tracking) the rotor angle (θ).

Because the tracking loop continuously updates digital angle value (φ) representing the angular position of the rotor, the speed of the rotor may also be derived, for example from the digital error signal 349 output by processing circuit 340. Because the integral of speed is position, the pre-integration input to feedback circuit 350 (which may digitally integrate digital error signal 349) may also represent speed. Thus, although not shown specifically in FIG. 3, the digital error signal 349 may also be provided as speed information to the higher-level system in which position sensor system 300 is incorporated.

Although an embodiment of processing circuit 340 is illustrated in FIG. 3 with transconductance amplifier 342, integrator 344, and ADC 348 coupled in successive stages of the signal path, the components of processing circuit 340 may be arranged in any suitable manner. For example, in some embodiments, an ADC such as ADC 348 may be placed directly at the output of low-pass filter 330 or at the output of transconductance amplifier 342. In such embodiments, further amplification and/or integration may then be implemented in the digital domain after the ADC to generate digital error signal 349. Further, in such embodiments, low-pass filter 330 may optionally be omitted and the filtering may be implemented in the digital domain by a digital filter downstream from the ADC.

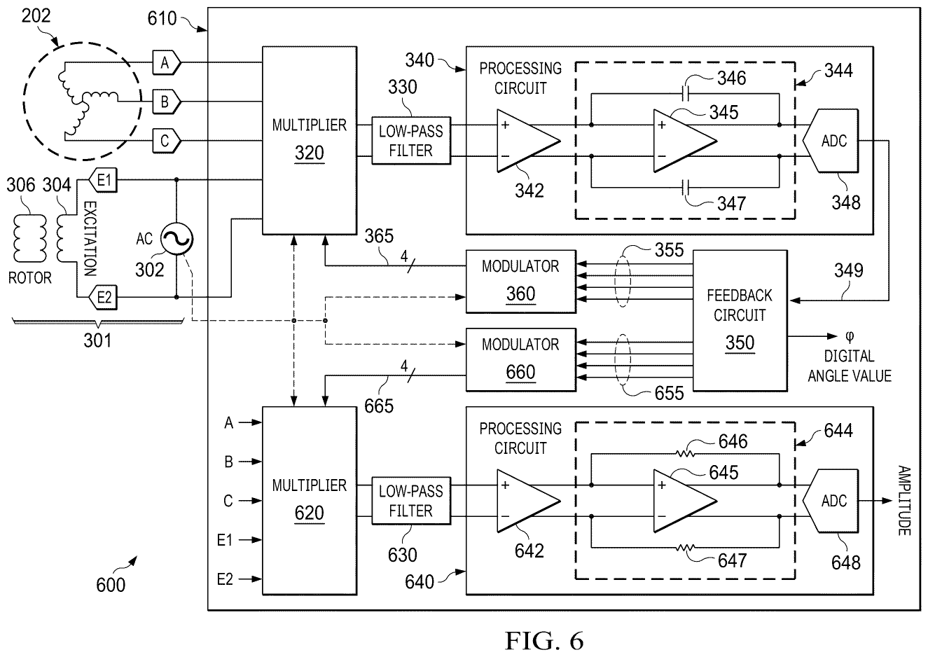

FIG. 6 illustrates a schematic diagram of position sensor system 600 in accordance with embodiments of the present disclosure. Position sensor system 600 may be implemented in any suitable fashion according to the operation described in the present disclosure. As shown in FIG. 6, position sensor system 600 may include angular position sensor 301. Position sensor system 600 may further include position sensor interface 610. Similar to position sensor interface 310 described above with reference to FIG. 3, position sensor interface 610 may include a tracking loop with multiplier 320, low-pass filter 330, processing circuit 340, feedback circuit 350, and modulator 360. The angular position sensor 301 and the tracking loop formed by multiplier 320, low-pass filter 330, processing circuit 340, feedback circuit 350, and modulator 360, may operate in the same manner as described above for FIG. 3.

As shown in FIG. 6, position sensor interface 610 may also include an amplitude-detection path having a second modulator 660, a second multiplier 620, a second low-pass filter 630, and a second processing circuit 640. As described in further detail below, the amplitude-detection path including second modulator 660, second multiplier 620, second low-pass filter 630, and second processing circuit 640 may operate in a similar manner as the tracking loop, but may output an amplitude value indicating the amplitude of the various differential receiver signals Rec₁, Rec₂, and Rec₃. In turn, the amplitude value may be used, for example, to set the gain of transconductance amplifier 342 (and second transconductance amplifier 642), and/or to detect a rotor failure. For example, a significant drop in the amplitude value may indicate a missing or otherwise broken rotor.

As shown in FIG. 6, in addition to generating a plurality of digital feedback signals 355 based on digital error signal 349, feedback circuit 350 may also be configured to generate a second plurality of feedback signals 655 based on digital error signal 349. The second plurality of feedback signals 655 may include a first feedback-sine signal, a second feedback-sine signal, a third feedback-sine signal, and a fourth feedback-sine signal, based at least on the digital angle value (φ) which is continuously updated by feedback circuit 350 to track rotor angle (θ). The second plurality of feedback signals 655 may be expressed according to equations 10-13 below.

FB₂₁=sin (φ) [equation 10]

FB₂₂=sin (φ+120) [equation 11]

FB₂₃=sin (φ+240) [equation 12]

$$F B {2}_{4} = - {\sum }_{i = 1}^{3} \frac{{B}_{i}}{{B}_{4}} sin ( φ + ( ( i * 120 ) - 120 ) ) \qquad [ equation 13 ]$$

The second plurality of feedback signals 655 may be provided by feedback circuit 350 to second modulator 660. Second modulator 660 may be configured to convert the second plurality of feedback signals 655 from feedback circuit 350 into a second plurality of pulse-density modulated (PDM) signals 665. Second modulator 660 may operate in a similar manner as modulator 360 described above. For example, second modulator 660 may be a sigma-delta modulator. As shown in FIG. 6, second modulator 660 may be synchronized to the frequency of the excitation signal provided by AC source 302. For example, in embodiments where AC source 302 provides a 4 MHz excitation signal, second modulator 660 may output the second plurality of PDM signals 665 at a frequency of 4 MHz. The respective pulse densities of the second plurality of PDM signal 665 may correspond to the digital values of the second plurality of feedback signals 655. Accordingly, the second plurality of PDM signals 665 may comprise pulse-density modulated representations of the feedback signals FB2₁, FB2₂, FB2₃, and FB2₄ described above in equations 10-13. Although second modulator 660 is illustrated in FIG. 6 as a single circuit block, second modulator 660 may include multiple components. For example, second modulator 660 may include or be implemented by multiple modulators (for example sigma-delta modulators) each configured to modulate a respective one of the second plurality of feedback signals 655.

As shown in FIG. 6, second multiplier 620 may be configured to receive the second plurality of PDM signals 665 from second modulator 660. In some embodiments, second multiplier 620 may be configured to respectively multiply the second plurality of PDM signals 665 and the plurality of differential receiver signals (Rec₁, Rec₂, Rec₃, Rec₄). For example, second multiplier 620 may be implemented in the same manner and may represent a second instance of multiplier 320, but may multiply the plurality of differential receiver signals (Rec₁, Rec₂, Rec₃, Rec₄) with the second plurality of PDM signals 665 as opposed to the first plurality of PDM signals 365. Accordingly, second multiplier 620 may include second plurality of analog multiplexors configured to receive the plurality of differential receiver signals, each of the second plurality of analog multiplexors having a differential multiplexor output coupled to a differential output of the second multiplier. The second multiplier 620 may further include a second control circuit configured to control each of the second plurality of analog multiplexors based on the second plurality of PDM signals 665. The second plurality of analog multiplexors and the second control circuit of second multiplier 620 may operate in a similar manner as described for the plurality of analog multiplexors 322a-d and control circuit 321 with reference to FIGS. 3-5 in order to respectively multiply the second plurality of PDM signals 665 with the plurality of differential receiver signals (Rec₁, Rec₂, Rec₃, Rec₄).

By multiplying the plurality of receiver signals (Rec₁, Rec₂, Rec₃, Rec₄) by a second plurality of PDM signals 665 representing the feedback-sine signals of equations 10-13 instead of multiplying by the plurality of PDM signals 365 representing the cosine signals of equations 5-8, the output of second multiplier 620 will provide a signal dependent on the amplitude of the plurality of receiver signals (Rec₁, Rec₂, Rec₃, Rec₄). As shown in FIG. 6, a second low-pass filter 630 may be coupled to filter the differential output of second multiplier 620. In turn, second processing circuit 640 may be configured to output an amplitude value AMPLITUDE based on a filtered output of second multiplier 620.

Second processing circuit 640 may be implemented in any suitable fashion according to the operation described in the present disclosure. Second processing circuit 640 may amplify the output of second low-pass filter 630 and convert the signal from the analog domain to the digital domain. In some embodiments, second processing circuit 640 may include second transconductance amplifier 642, gain stage 644, and second analog-to-digital converter (ADC) 648. Second transconductance amplifier 642 may be configured to amplify the output of second low-pass filter 630. Gain stage 644 may be configured to amplify an output of second transconductance amplifier 642. For example, gain stage 644 may include second amplifier 645 having differential inputs coupled to the differential outputs of second transconductance amplifier 642. Further, gain stage 644 may include a first resistor 646 coupled from a first differential input to a first differential output of second amplifier 645, and a second resistor 647 coupled from a second differential input to a second differential output of second amplifier 645. Second ADC 648 may be configured to receive a gain-stage output from gain stage 644 and to generate the amplitude value AMPLITUDE. In turn, the amplitude value may be used, for example, to set the gain of transconductance amplifier 342 (and second transconductance amplifier 642), and/or to detect a rotor failure. For example, a significant drop in the amplitude value may indicate a missing or otherwise broken rotor.

Although an embodiment of second processing circuit 640 is illustrated in FIG. 6 with second transconductance amplifier 642, gain stage 644, and second ADC 648 coupled in successive stages of the signal path, the components of second processing circuit 640 may be arranged in any suitable manner. For example, in some embodiments, an ADC such as second ADC 648 may be placed directly at the output of second low-pass filter 630 or at the output of second transconductance amplifier 642. In such embodiments, further amplification or filtering may then be implemented in the digital domain after the ADC to generate the amplitude value AMPLITUDE.

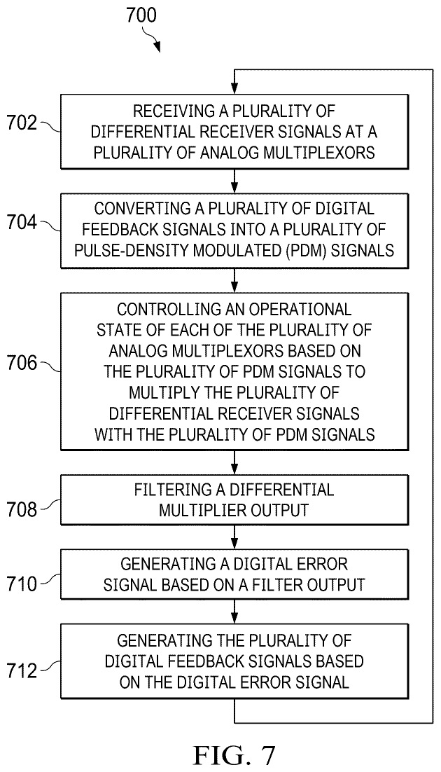

FIG. 7 illustrates operation of an example method 700 of operating a position sensor interface in accordance with embodiments of the present disclosure. Method 700 may be performed by any suitable mechanism, such as position sensor interface 310, position sensor interface 610, and/or any suitable combination of the components included therein. In some embodiments, method 700 may be performed with fewer or more steps than shown in FIG. 7.

Step 702 may include receiving a plurality of differential receiver signals at a plurality of analog multiplexors. For example, as described above with reference to FIG. 3, a plurality of analog multiplexors 322a-d within the multiplier 320 of position sensor interface 310 may receive a plurality of differential receiver signals (Rec₁, Rec₂, Rec₃) from angular position sensor 301. Position sensor interface 310 may also receive Rec₄ corresponding to the AC source 302. As shown in FIG. 3, analog multiplexor 322a may receive the first differential receiver signal (Rec₁), analog multiplexor 322b may receive the second differential receiver signal (Rec₂), analog multiplexor 322c may receive the third differential receiver signal (Rec₃), and analog multiplexor 322d may receive the fourth differential receiver signal (Rec₄).

Step 704 may include converting a plurality of digital feedback signals into a plurality of pulse-density modulated (PDM) signals. For example, as described above with reference to FIG. 3, modulator 360 may be coupled to receive the plurality of digital feedback signals 355 from feedback circuit 350. Modulator 360 may be configured to convert the plurality of digital feedback signals 355 into a plurality of pulse-density modulated (PDM) signals 365. In some embodiments, modulator 360 may be a sigma-delta modulator. As shown in FIG. 3, modulator 360 may be synchronized to the frequency of the excitation signal provided by AC source 302. For example, in embodiments where AC source 302 provides a 4 MHz excitation signal, modulator 360 may output the plurality of PDM signals 365 at a frequency of 4 MHz. The respective pulse densities of the plurality of PDM signal 365 may correspond to the digital values of the respective digital feedback signals 355. Accordingly, the plurality of PDM signals 365 may comprise pulse-density modulated representations of the feedback signals FB₁, FB₂, FB₃, and FB₄ described above in equations 5-8.

Step 706 may include controlling an operational state of each of the plurality of analog multiplexors based on the plurality of PDM signals to multiply the plurality of differential receiver signals with the plurality of PDM signals. For example, as described above with reference to FIGS. 3, 4, and 5, control circuit 321 may control the operational state (either high-impedance operation or inverting or non-inverting rectification) of each of the plurality of analog multiplexors 322a-d based on the plurality of PDM signals 365 to effectively multiply the plurality of differential receiver signals (Rec₁, Rec₂, Rec₃, and Rec₄) with the plurality of PDM signals 365 that respectively comprise pulse-density modulated representations of the feedback signals FB₁, FB₂, FB₃, and FB₄ described above in equations 5-8.

Step 708 may include filtering a differential multiplier output. For example, as described above with reference to FIG. 3, low-pass filter 330 may filter the differential output 325 of multiplier 320.

Step 710 may include generating a digital error signal based on a filter output. For example, as described above with reference to FIG. 3, processing circuit 340 may be coupled to low-pass filter 330 to receive the filter output 335. Processing circuit 340 may be configured to output the digital error signal 349 based on the filter output 335. In some embodiments, processing circuit 340 may include transconductance amplifier 342, integrator 344, and analog-to-digital converter (ADC) 348. Thus, processing circuit 340 may amplify the output of low-pass filter 330, integrate the amplified output, and convert the signal from the analog domain to the digital domain to generate digital error signal 349.

Step 712 may include generating the plurality of digital feedback signals based on the digital error signal. For example, as described above with reference to FIG. 3, feedback circuit 350 may be configured to generate a plurality of digital feedback signals 355 based on the digital error signal 349 from processing circuit 340. The plurality of digital feedback signals 355 may comprise digital representations of the feedback signals FB₁, FB₂, FB₃, and FB₄ described above in equations 5-8.

As described above with reference to FIG. 3, the components of position sensor interface 310, including multiplier 320, low-pass filter 330, processing circuit 340, feedback circuit 350, and modulator 360 may serve as a tracking loop whereby feedback circuit 350 continuously updates a digital angle value (φ) to target a value of zero for digital error signal 349, thus providing digital angle value (φ) that tracks the rotor angle (θ). The steps of method 700 may thus be continuously repeated. Further, the steps of method 700 may be considered as being continuously performed in parallel to each other as the tracking loop continuously updates the digital angle value (φ).

Although examples have been described above, other modifications and variations may be made from this disclosure without departing from the spirit and scope of these examples. The above descriptions of various embodiments illustrate the principles of the invention. Numerous variations and modifications will become apparent to those skilled in the art based on the above disclosure. The following claims are intended to embrace all such variations and modifications.

1. A position sensor interface, comprising:
a modulator configured to convert a plurality of digital feedback signals into a plurality of pulse-density modulated (PDM) signals; and
a multiplier configured to respectively multiply the plurality of PDM signals with a plurality of differential receiver signals, the multiplier including:
a plurality of analog multiplexors configured to receive the plurality of differential receiver signals, each of the plurality of analog multiplexors having a differential multiplexor output coupled to a differential output of the multiplier; and
a control circuit configured to control each of the plurality of analog multiplexors based on the plurality of PDM signals.

2. The position sensor interface of claim 1, wherein based on the plurality of PDM signals, each of the plurality of analog multiplexors is configured to provide one of a non-inverting rectification of a respective one of the plurality of differential receiver signals, an inverting rectification of the respective one of the plurality of differential receiver signals, or a high-impedance output.

3. The position sensor interface of claim 1, wherein the modulator is a sigma-delta modulator.

4. The position sensor interface of claim 1, further comprising:
a low-pass filter coupled to filter the differential output of the multiplier;
a processing circuit configured to output a digital error signal based on a filter output; and
a feedback circuit configured to generate the plurality of digital feedback signals based on the digital error signal.

5. The position sensor interface of claim 4, wherein the processing circuit comprises:
a transconductance amplifier configured to amplify the filter output;
an integrator configured to integrate an output of the transconductance amplifier; and
an analog-to-digital converter (ADC) configured to receive an integrator output and to generate the digital error signal.

6. The position sensor interface of claim 1, wherein:
the plurality of digital feedback signals include a first cosine signal, a second cosine signal, and a third cosine signal, based at least on a digital angle value; and
the plurality of differential receiver signals include a first sine signal, a second sine signal, and a third sine signal, based at least on a rotor angle of a position sensor.

7. The position sensor interface of claim 6, wherein:
the plurality of differential receiver signals further includes a fourth signal based at least on a excitation amplitude of the position sensor; and
the plurality of digital feedback signals further include a fourth cosine signal based at least on the digital angle value.

8. The position sensor interface of claim 4, further comprising an amplitude-detection path including:
a second modulator configured to convert a second plurality of feedback signals from the feedback circuit into a second plurality of pulse-density modulated (PDM) signals;
a second multiplier configured to respectively multiply the second plurality of PDM signals and the plurality of differential receiver signals, the second multiplier including:
a second plurality of analog multiplexors configured to receive the plurality of differential receiver signals, each of the second plurality of analog multiplexors having a differential multiplexor output coupled to a differential output of the second multiplier; and
a second control circuit configured to control each of the second plurality of analog multiplexors based on the second plurality of PDM signals;
a second low-pass filter coupled to filter the differential output of the second multiplier; and
a second processing circuit configured to output an amplitude value based on a filtered output of the second multiplier.

9. The position sensor interface of claim 8, wherein the second processing circuit comprises:
a second transconductance amplifier configured to amplify an output of the second low-pass filter;
a gain stage configured to amplify an output of the second transconductance amplifier; and
a second ADC configured to receive a gain-stage output and generate the amplitude value.

10. The position sensor interface of claim 8, wherein:
the plurality of differential receiver signals include a first sine signal, a second sine signal, and a third sine signal, based at least on a rotor angle of a position sensor; and
the second plurality of feedback signals includes a first feedback-sine signal, a second feedback-sine signal, a third feedback-sine signal, and a fourth feedback-sine signal, based at least on a digital angle value.

11. A position sensor system, comprising:
an excitation coil configured to be driven by an AC source;
a rotor coil inductively coupled to the excitation coil;
a plurality of receiver coils coupled in a Y-configuration and inductively coupled to the rotor coil; and
a position sensor interface configured to receive a plurality of differential receiver signals from the plurality of receiver coils, the position sensor interface comprising:
a modulator configured to convert a plurality of digital feedback signals into a plurality of pulse-density modulated (PDM) signals; and
a multiplier configured to respectively multiply the plurality of PDM signals with the plurality of differential receiver signals, the multiplier including:
a plurality of analog multiplexors configured to receive the plurality of differential receiver signals, each of the plurality of analog multiplexors having a differential multiplexor output coupled to a differential output of the multiplier; and
a control circuit configured to control each of the plurality of analog multiplexors based on the plurality of PDM signals.

12. The position sensor system of claim 11, wherein based on the plurality of PDM signals, each of the plurality of analog multiplexors is configured to provide one of a non-inverting rectification of a respective one of the plurality of differential receiver signals, an inverting rectification of the respective one of the plurality of differential receiver signals, or a high-impedance output.

13. The position sensor system of claim 11, wherein the modulator is a sigma-delta modulator.

14. The position sensor system of claim 11, further comprising:
a low-pass filter coupled to filter the differential output of the multiplier;
a processing circuit configured to output a digital error signal based on a filter output; and
a feedback circuit configured to generate a plurality of digital feedback signals based on the digital error signal.

15. The position sensor system of claim 14, wherein the processing circuit comprises:
a transconductance amplifier configured to amplify the filter output;
an integrator configured to integrate an output of the transconductance amplifier; and
an analog-to-digital converter (ADC) configured to receive an integrator output and generate the digital error signal.

16. A method of operating a position sensor interface, comprising:
receiving a plurality of differential receiver signals at a plurality of analog multiplexors;
converting a plurality of digital feedback signals into a plurality of pulse-density modulated (PDM) signals; and
controlling an operational state of each of the plurality of analog multiplexors based on the plurality of PDM signals to multiply the plurality of differential receiver signals with the plurality of PDM signals.

17. The method of claim 16, further comprising:
filtering a differential multiplier output;
generating a digital error signal based on a filter output; and
generating the plurality of digital feedback signals based on the digital error signal.

18. The method of claim 16, wherein:
the plurality of differential receiver signals include a first sine signal, a second sine signal, and a third sine signal, based at least on a rotor angle of a position sensor;
the plurality of digital feedback signals include a first cosine signal, a second cosine signal, and a third cosine signal, based at least on a digital angle value; and
the first sine signal is multiplied by the first cosine signal, the second sine signal is multiplied by the second cosine signal, and the third sine signal is multiplied by the third cosine signal.

19. The method of claim 18, wherein:
the plurality of differential receiver signals further includes a fourth signal based at least on a excitation amplitude of the position sensor;
the plurality of digital feedback signals further include a fourth cosine signal based at least on the digital angle value; and
the fourth signal is multiplied by the fourth cosine signal.

20. The method of claim 16, wherein based on the plurality of PDM signals, each of the plurality of analog multiplexors is configured to provide one of a non-inverting rectification of a respective one of the plurality of differential receiver signals, an inverting rectification of the respective one of the plurality of differential receiver signals, or a high-impedance operation.
